(19) United States
(12) Patent Application Publication
(10) Pub. No.: US 2026/0203120 A1
(43) Pub. Date: Jul. 16, 2026

(54) MODEL MANAGEMENT METHODS AND APPARATUSES

(71) Applicant: Beijing Xiaomi Mobile Software Co., Ltd., Beijing (CN)

(72) Inventor: Qin MU, Beijing (CN)

(21) Appl. No.: 19/137,898

(22) PCT Filed: Dec. 19, 2022
(86) PCT No.: PCT/CN2022/140162

§ 371 Date: Jun. 11, 2025

(51) Int. Cl. G06F 9/50

(52) U.S. Cl. CPC G06F 9/5027

(57) ABSTRACT

A model management method is performed by a network side device, and includes: transmitting an artificial intelligence (AI) model management indication, wherein the AI model management indication is configured to indicate a terminal in a specific user group to perform a specific operation to complete a specific model task.

### CROSS REFERENCE TO RELATED APPLICATIONS

This application is a US National Phase of a PCT Application No. PCT/CN2022/140162 filed on Dec. 19, 2022, the entire contents of which are incorporated herein by reference.

### TECHNICAL FIELD

The present disclosure relates to the field of communication technology, particularly to model management methods and apparatuses.

### BACKGROUND

In related arts, the application of artificial intelligence (AI) models in wireless communication is proposed, but it only supports the management of AI models for a single terminal and does not support the management of AI models for multiple terminals simultaneously, which is an urgent problem that needs to be solved.

### SUMMARY

The embodiments of the present disclosure provide model management methods and apparatuses that support simultaneous management of AI models for multiple terminals, thereby improving model management efficiency.

In a first aspect, the embodiments of the present disclosure provide a model management method, performed by a network side device, including: transmitting, by the network side device, an AI model management indication, where the AI model management indication is configured to indicate a terminal in a specific user group to perform a specific operation to complete a specific model task.

In this technical solution, the network side device transmits the AI model management indication, where the AI model management indication is configured to indicate terminals in a specific user group to perform a specific operation to complete a specific model task. Therefore, the management of AI models for multiple terminals simultaneously is supported, which can improve the efficiency of model management.

In a second aspect, the embodiments of the present disclosure provide another model management method, performed by a terminal, including: receiving an AI model management indication transmitted by a network side device, where the AI model management indication is configured to indicate the terminal in a specific user group to perform a specific operation to complete a specific model task.

In a third aspect, the embodiments of the present disclosure provide a communication apparatus that has the ability to implement some or all of the functions of the network side device in the method described in the first aspect. For example, the communication apparatus can have some or all of the functions in the embodiments of the present disclosure, or can have the function of separately implementing any one of the embodiments in the present disclosure. The functions described can be implemented through hardware or by executing corresponding software through hardware. The hardware or software includes one or more units or modules corresponding to the above functions.

In an embodiment, the structure of the communication apparatus can include a transceiver module and a processing module, where the processing module is configured to support the communication apparatus in executing the corresponding functions in the above method. The transceiver module is configured to support communication between the communication apparatus and other devices. The communication apparatus may further include a storage module. The storage module is configured to couple with the transceiver module and the processing module. The storage module stores a necessary computer program and data for the communication apparatus.

In an embodiment, the communication apparatus includes a transceiver module, configured to transmit an artificial intelligence (AI) model management indication, where the AI model management indication is configured to indicate a terminal in a specific user group to perform a specific operation to complete a specific model task.

In a fourth aspect, the embodiments of the present disclosure provide a communication apparatus that has the ability to implement some or all of the functions of the terminal in the method described in the second aspect. For example, the communication apparatus can have some or all of the functions in the embodiments of the present disclosure, or can have the function of separately implementing any one of the embodiments in the present disclosure. The functions described can be implemented through hardware or by executing corresponding software through hardware. The hardware or software includes one or more units or modules corresponding to the above functions.

In an embodiment, the structure of the communication apparatus can include a transceiver module and a processing module, where the processing module is configured to support the communication apparatus in executing the corresponding functions in the above method. The transceiver module is configured to support communication between the communication apparatus and other devices. The communication apparatus may further include a storage module. The storage module is configured to couple with the transceiver module and the processing module. The storage module stores a necessary computer program and data for the communication apparatus.

In an embodiment, the communication apparatus includes a transceiver module, configured to receive an AI model management indication transmitted by a network side device, where the AI model management indication is configured to indicate the terminal in a specific user group to perform a specific operation to complete a specific model task.

In a fifth aspect, the embodiments of the present disclosure provide a communication device including one or more processors, where when the one or more processors call a computer program stored in one or more memories, the method described in the first aspect is executed.

In a sixth aspect, the embodiments of the present disclosure provide a communication device including one or more processors, where when the one or more processors call a computer program stored in one or more memories, the method described in the second aspect is executed.

In a seventh aspect, the embodiments of the present disclosure provide a communication device, including one or more processors and one or more memories, where a computer program is stored in the one or more memories, and the one or more processors execute the computer program stored in the one or more memories to enable the communication device to execute the method described in the first aspect.

In an eighth aspect, the embodiments of the present disclosure provide a communication device, including one or more processors and one or more memories, where a computer program is stored in the one or more memories, and the one or more processors execute the computer program stored in the one or more memories to enable the communication device to execute the method described in the second aspect.

In a ninth aspect, the embodiments of the present disclosure provide a communication device, including one or more processors and an interface circuit; where the interface circuit is configured to receive code instructions and transmit the code instructions to the one or more processors; and the one or more processors are configured to run the code instructions to execute the method described in the first aspect.

In a tenth aspect, the embodiments of the present disclosure provide a communication device, including one or more processors and an interface circuit; where the interface circuit is configured to receive code instructions and transmit the code instructions to the one or more processors; and the one or more processors are configured to run the code instructions to execute the method described in the second aspect.

In an eleventh aspect, the embodiments of the present disclosure provide a model management system including the communication device as described in the third aspect and the communication device as described in the fourth aspect, or including the communication device as described in the fifth aspect and the communication device as described in the sixth aspect, or including the communication device as described in the seventh aspect and the communication device as described in the eighth aspect, or including the communication device as described in the ninth aspect and the communication device as described in the tenth aspect.

In a twelfth aspect, the embodiments of the present disclosure provide a computer-readable storage medium storing instructions used by the network side device, where when the instructions are executed, the side network side device executes the method described in the first aspect.

In a thirteenth aspect, the embodiments of the present disclosure provide a readable storage medium storing instructions used by the terminal, where when the instructions are executed, the terminal executes the method described in the second aspect.

In a fourteenth aspect, the present disclosure further provides a computer program product including a computer program, where when the computer program runs on a computer, the computer executes the method described in the first aspect.

In a fifteenth aspect, the present disclosure further provides a computer program product including a computer program, where when the computer program runs on a computer, the computer executes the method described in the second aspect.

In a sixteenth aspect, the present disclosure provides a chip system including one or more processors and an interface to support the network side device in implementing the functions involved in the first aspect, such as determining or processing at least one of data or information involved in the above method. In some embodiments, the chip system further includes one or more memories for storing a computer program and data necessary for the network side device. The chip system can be composed of one or more chips or include one or more chips and other discrete devices.

In a seventeenth aspect, the present disclosure provides a chip system including one or more processors and an interface to support the terminal in implementing the functions involved in the second aspect, such as determining or processing at least one of data or information involved in the above method. In some embodiments, the chip system further includes one or more memories for storing a computer program and data necessary for the terminal. The chip system can be composed of one or more chips or include one or more chips and other discrete devices.

In an eighteenth aspect, the present disclosure provides a computer program, where when the computer program runs on a computer, the computer executes the method described in the first aspect.

In a nineteenth aspect, the present disclosure provides a computer program, where when the computer program runs on a computer, the computer executes the method described in the second aspect.

### BRIEF DESCRIPTION OF DRAWINGS

FIG. 1 is a schematic structural diagram of a communication system provided in the embodiments of the present disclosure.

FIG. 2 is a flowchart of a model management method provided in the embodiments of the present disclosure.

FIG. 3 is a flowchart of a model management method provided in the embodiments of the present disclosure.

FIG. 4 is a flowchart of a model management method provided in the embodiments of the present disclosure.

FIG. 5 is a flowchart of a model management method provided in the embodiments of the present disclosure.

FIG. 6 is a structural diagram of a communication apparatus provided in the embodiments of the present disclosure.

FIG. 7 is a schematic structural diagram of a communication device provided in the embodiments of the present disclosure.

FIG. 8 is a schematic structural diagram of a chip provided in the embodiments of the present disclosure.

### DETAILED DESCRIPTION

To better understand the model management methods and apparatuses in the embodiments of the present disclosure, the following first describes the communication system applicable to the embodiments of the present disclosure.

The following describes in detail the embodiments of the present disclosure, examples of the embodiments are shown in the accompanying drawings, where identical or similar labels throughout represent identical or similar components or components with identical or similar functions. The embodiments described below with reference to the accompanying drawings are exemplary and intended to explain the present disclosure, but cannot be understood as limiting the present disclosure. In the description of the present disclosure, unless otherwise specified, “/” represents or, for example, A/B can represent A or B; and the term “and/or” in this article is only a description of the association relationship of associated objects, indicating that there can be three types of relationships, such as, A and/or B can represent three situations of A alone, A and B simultaneously, and B alone.

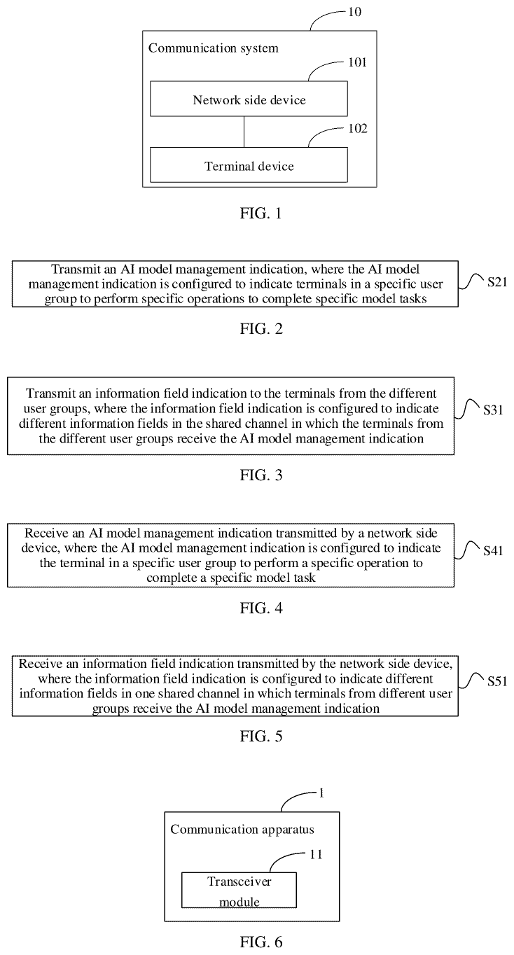

Referring to FIG. 1, FIG. 1 is a schematic structural diagram of a communication system according to embodiments of the present disclosure. The communication system can include but is not limited to one network side device and one terminal. The number and form of devices shown in FIG. 1 are only for example and do not constitute a limitation on the embodiments of the present disclosure. In practical applications, the communication system can include two or more network devices, or two or more terminals. The communication system shown in FIG. 1 includes one network side device 101 and one terminal 102 as an example.

It should be noted that the technical solution of the embodiments of the present disclosure can be applied to various communication systems, such as a long term evolution (LTE) system, a 5th generation (5G) mobile communication system, a 5G new radio (NR) system, or other future new mobile communication systems.

The network side device 101 in the embodiments of the present disclosure is an entity for transmitting or receiving signals on the network side. For example, the network side device 101 can be an evolved NodeB (eNB), a transmission reception point (TRP), a next generation NodeB (gNB) in an NR system, base stations in other future mobile communication systems, or access nodes in wireless fidelity (WiFi) systems. The embodiments of the present disclosure do not limit the specific technology or specific device form adopted by the base station. The base station provided in the embodiments of the present disclosure can be composed of a central unit (CU) and a distributed unit (DU), where the CU can also be referred to as a control unit. The base station (such as a protocol layer of the base station) can be separated by the CU-DU structure, where some functions of the protocol layer are distributed in the CU and centrally controlled, and a part of or all of the remaining functions of the protocol layer are distributed in the DU, where the DU is centrally controlled by the CU.

The terminal 102 in the embodiments of the present disclosure is an entity for receiving or transmitting signals on the user side, such as a mobile phone. The terminal can also be referred to as user equipment (UE), a terminal, a mobile station (MS), or a mobile terminal (MT). The terminal can include a car, a smart car, a mobile phone, a wearable device, a pad, a computer with a wireless transmission and reception capability, a virtual reality (VR) terminal, an augmented reality (AR) terminal, a wireless terminal in industrial control, a wireless terminal in self driving, a wireless terminal in remote medical surgery, a wireless terminal in smart grid, a wireless terminal in transportation security, a wireless terminal in smart city, or a wireless terminal in smart home, that has a communication capability. The embodiments of the present disclosure do not limit the specific technology or specific device form adopted by the terminal.

It can be understood that the communication system described in the embodiments of the present disclosure is intended to provide a clearer explanation of the technical solutions in the embodiments of the present disclosure, and does not constitute a limitation on the technical solutions provided in the embodiments of the present disclosure. As those skilled in the art know, with the evolution of the system architecture and the emergence of new service scenarios, the technical solutions provided in the embodiments of the present disclosure are also applicable to similar technical problems.

In addition, in order to facilitate the understanding of the embodiments of the present disclosure, the following points are made for description.

Firstly, in the embodiments of the present disclosure, “being configured to indicate” may include both being configured to directly indicate and being configured to indirectly indicate. When describing that a piece of information is configured to indicate A, it may include that the piece of information directly indicates A or the piece of information indirectly indicates A, and does not mean that the piece of information necessarily carries A in it.

Information indicated by the information is called to-be-indicated information. In the specific implementation process, there are many ways to indicate the to-be-indicated information, such as but not limited to directly indicating the to-be-indicated information, such as indicating the information itself or the index of the to-be-indicated information; or indirectly indicating the to-be-indicated information by indicating other information, where there is a correlation between the other information and the to-be-indicated information; or indicating only a part of the to-be-indicated information, where the other part of the to-be-indicated information are known or pre-agreed. For example, a pre-agreed (e.g., by protocol definition) arrangement order of various information can be used to achieve the indication of specific information, thereby reducing the indication overhead to a certain extent.

The to-be-indicated information can be transmitted together as a whole or divided into multiple sub information to be transmitted separately, and the transmitting period and/or transmitting timing of these sub information can be the same or different. The specific transmitting method is not limited in the present disclosure. Where the transmitting period and/or transmitting timing of these sub information can be pre-defined, such as according to the protocol.

Secondly, in the present disclosure, the first, second, and various numerical designations (e.g., “#1”, “#2”) are only used for convenience of description and are not intended to limit the scope of the embodiments of the present disclosure, such as to distinguish different types of information.

Thirdly, the “protocol” referred to in the embodiments of the present disclosure may refer to standard protocols in the field of communication, such as LTE protocol, NR protocol, Wireless Local Area Network (WLAN) protocol, and other relevant protocols in communication systems, which is not limited in the present disclosure.

Fourthly, the embodiments of the present disclosure list multiple embodiments to clearly illustrate the technical solutions of the embodiments of the present disclosure. Those skilled in the art can understand that each of the multiple implementations provided in the embodiments of the present disclosure can be executed separately, can be combined with the methods of other embodiments in the present disclosure, can be executed in combination with some methods in other related arts, or can be executed in combination with the methods of other embodiments in the present disclosure and some methods in other related arts, which is not limited in the embodiments of the present disclosure.

The widespread application of 5G technology will bring tremendous changes to various aspects of people's lives. According to the vision of the International Telecommunication Union (ITU), 5G will penetrate into various fields of future society, building a comprehensive information ecosystem centered on users. Where the 5G user experience rate can reach 100 Mbit/s~1 Gbit/s, which can support extreme business experiences such as mobile virtual reality. The peak speed of 5G can reach 10 Gbit/s~20 Gbit/s, and the traffic density can reach 10 Mbit/s/m2, which can support the growth of mobile business traffic by more than a thousand times in the future. The connection density of 5G can reach 1 million/m2 , which can effectively support a massive number of IoT devices. The transmission latency of 5G can reach the millisecond level, which can meet the strict requirements of vehicle network and industrial control. 5G can be supported for a moving speed of 500 km/h and provide a good user experience in high-speed rail environments. It can be foreseen that 5G, as a representative of new infrastructure, will reconstruct the future information society.

Artificial intelligence (AI) technology makes continuous breakthroughs in multiple fields. The continuous development of intelligent voice, computer vision and other fields not only brings rich and colorful applications to intelligent terminals, but also has extensive applications in education, transportation, home furnishings, healthcare, retail, security and other fields, bringing convenience to people's lives and promoting industrial upgrading in various industries. AI technology also accelerates its cross penetration with other fields, integrating knowledge from different fields and providing new directions and methods for the development of different fields.

In Release 18 of the 3rd Generation Partnership Project (3GPP), the RAN1 established a research project on artificial intelligence (AI) technologies in the radio air interface. The project aims to research how to introduce artificial intelligence technology into radio air interfaces and investigate how artificial intelligence technology can assist in improving the transmission technology of radio air interfaces.

In the research of wireless AI, application cases of artificial intelligence include: AI-based channel state information (CSI) enhancement, AI-based beam management, AI-based positioning, and so on.

In AI-based wireless communication use cases, the first is to collect data to train the model. The trained model can be deployed on both the network side device and the terminal. In the practical application of AI models, it is also necessary to monitor the inference performance of AI models. When the inference performance of the AI model decreases, the use of the AI model can be turned off. Alternatively, when the current environment is suitable for the AI model, the AI model can be activated. In addition, multiple AI models may be deployed for the same function, and models may also be switched when the environment changes. In addition, the deployed models can also be updated based on changes in data distribution over time.

In related arts, the management of AI models focuses on managing AI models for an individual terminal. However, in practical deployment scenarios, it may not be possible to monitor the performance of an individual terminal. For example, in AI-based positioning scenarios, the positioning performance of the entire scenario is monitored based on a positioning reference unit (PRU). If the model management method for an individual terminal is still used in this case, the overall model management efficiency will decrease.

Based on this, in the embodiments of the present disclosure, the network side device transmits artificial intelligence (AI) model management indication, where the AI model management indication is configured to indicate terminals in a specific user group to perform specific operations to complete specific model tasks. Therefore, the management of AI models for multiple terminals simultaneously is supported, which can improve the efficiency of model management.

Below, a detailed introduction will be given to the model management methods and apparatuses provided in the present disclosure, in conjunction with the accompanying drawings.

Referring to FIG. 2, FIG. 2 is a flowchart of a model management method provided in the embodiments of the present disclosure. As shown in FIG. 2, the method is performed by the network side device, and the method may include but is not limited to the following step S21.

In S21, an AI model management indication is transmitted, where the AI model management indication is configured to indicate terminals in a specific user group to perform specific operations to complete specific model tasks.

In the embodiments of the present disclosure, the network side device can transmit an AI model management indication, where the AI model management indication can be transmitted to specific terminals through broadcast, multicast or unicast.

For example, the network side device can transmit any one of the following: physical downlink control channel (PDCCH), physical downlink shared channel (PDSCH), radio resource control (RRC), media access control control element (MAC CE), or downlink control information (DCI), etc., where any one of the PDCCH, PDSCH, RRC, MAC CE, or DCI, etc., carries the AI model management indication.

In the embodiments of the present disclosure, the AI model management indication is implemented based on the common indication. That is, one or more terminals in the user group monitor the common indication together. The common indication for model management of terminals in the user group is the same, instructing the terminals in the user group to perform the same specific operations to complete the same specific model tasks.

Where the AI model management indication is configured to indicate terminals in a specific user group to perform specific operations to complete specific model tasks.

In some implementations, the AI model management indication can carry a user group identifier to indicate the specific user group.

For example, the network side device transmits the AI model management indication, where the AI model management indication carries a user group identifier. After receiving the AI model management indication transmitted by the network side device, the terminal can compare the user group to which the terminal belongs with the user group identifier carried by the AI model management indication. If the user group to which the terminal belongs corresponds to the user group identifier, the terminal determines to perform the specific operation indicated by the AI model management indication to complete the specific model task.

It can be understood that before the network side device transmits the AI model management indication, the network side device can further receive the user group information (such as the user group identifier) reported by the terminal, to distinguish the terminals of different user groups. Based on this, the network side device can transmit the AI model management indication to indicate a terminal in a specific user group to perform a specific operation to complete a specific model task.

In the embodiments of the present disclosure, the user group may include one or more terminals.

In some implementations, the AI model management indication can carry a task identifier to indicate a terminal in a specific user group to perform a specific operation, to complete a specific model task corresponding to the task identifier.

In some embodiments, the specific model task includes at least one of the following:
a first task of activating a first model;
a second task of deactivating a second model;
a third task of switching to a third model;
a fourth task of updating a fourth model; or
a fifth task of falling back through a fifth model to a non-model operation.

In the embodiment of the present disclosure, the specific model task includes the first task of activating the first model. The network side device transmits the AI model management indication, where the AI model management indication is configured to indicate a terminal in a specific user group to perform a specific operation to complete the first task of activating the first model.

Where the first model can be obtained by training at the terminal or network side device. When the first model is obtained by training at the network side device, the network side can transmit the trained first model to the terminal in advance before transmitting the AI model management indication. When the first model is obtained by training at the terminal, the network side device can receive the model information reported by the terminal, where the model information indicates that the terminal is configured with the trained first model, such that the AI model management indication is transmitted to the terminal according to the model information, where the AI model management indication indicates the terminal to perform a specific operation to complete the first task of activating the first model.

In the embodiment of the present disclosure, the specific model task includes the second task of deactivating the second model. The network side device transmits the AI model management indication, where the AI model management indication is configured to indicate the terminal in a specific user group to perform a specific operation to complete the second task of deactivating the second model.

Where the second model can be obtained by training at the terminal or network side device. When the second model is obtained by training at the network side device, the network side can transmit the trained second model to the terminal in advance before transmitting the AI model management indication. When the second model is obtained by training at the terminal, the network side device can receive the model information reported by the terminal, where the model information indicates that the terminal is configured with the trained second model, such that the AI model management indication is transmitted to the terminal according to the model information, where the AI model management indication indicates the terminal to perform a specific operation to complete the second task of the deactivating the second model.

In the embodiment of the present disclosure, the specific model task includes the third task of switching to the third model. The network side device transmits the AI model management indication, where the AI model management indication is configured to indicate the terminal in a specific user group to perform a specific operation to complete the third task of switching to the third model.

Where the third model can be obtained by training at the terminal or network side device. When the third model is obtained by training at the network side device, the network side can transmit the trained third model to the terminal in advance before transmitting the AI model management indication. When the third model is obtained by training at the terminal, the network side device can receive the model information reported by the terminal, where the model information indicates that the terminal is configured with the trained third model, such that the AI model management indication is transmitted to the terminal according to the model information, where the AI model management indication indicates the terminal to perform a specific operation to complete the third task of switching to the third model.

In the embodiments of the present disclosure, the specific model task includes the fourth task of updating the fourth model. The network side device transmits the AI model management indication, where the AI model management indication is configured to indicate a terminal in a specific user group to perform a specific operation to complete the fourth task of updating the fourth model.

Where the fourth model can be obtained by training at the terminal or network side device. When the fourth model is obtained by training at the network side device, the network side can transmit the trained fourth model to the terminal in advance before transmitting the AI model management indication. When the fourth model is obtained by training at the terminal, the network side device can receive the model information reported by the terminal, where the model information indicates that the terminal is configured with the trained fourth model, such that the AI model management indication is transmitted to the terminal according to the model information, where the AI model management indication indicates the terminal to perform a specific operation to complete the fourth task of updating the fourth model.

In the embodiments of the present disclosure, the specific model task includes the fifth task of falling back through the fifth model to a non-model operation. The network side device transmits the AI model management indication, where the AI model management indication is configured to indicate a terminal in a specific user group to perform a specific operation to complete the fifth task of falling back through the fifth model to a non-model operation.

Where the fifth model can be obtained by training at the terminal or network side device. When the fifth model is obtained by training at the network side device, the network side can transmit the trained fifth model to the terminal in advance before transmitting the AI model management indication. When the fifth model is obtained by training at the terminal, the network side device can receive the model information reported by the terminal, where the model information indicates that the terminal is configured with the trained fifth model, such that the AI model management indication is transmitted to the terminal according to the model information, where the AI model management indication indicates the terminal to perform a specific operation, to complete the fifth task of falling back through the fifth model to a non-model operation.

In some embodiments, at least two of the first model, the second model, the third model, the fourth model, or the fifth model are different, or any two of the first model, the second model, the third model, the fourth model, or the fifth model are different from each other.

In some embodiments, the specific operation includes at least one of the following:
transmitting a reference signal related to the specific model task;
feedbacking information related to the specific model task;
receiving information related to the specific model task; or
performing a specific operation related to the specific model task.

In the embodiments of the present disclosure, the specific operation includes transmitting a reference signal related to the specific model task. The network side device transmits the AI model management indication, where the AI model management indication is configured to indicate a terminal in a specific user group to execute transmitting a reference signal related to the specific model task, to complete the specific model task.

In the embodiments of the present disclosure, the specific operation includes feedbacking information related to the specific model task. The network side device transmits AI model management indication, where the AI model management indication is configured to indicate a terminal in a specific user group to execute feedbacking information related to the specific model task, to complete the specific model task.

In the embodiments of the present disclosure, the specific operation includes receiving information related to the specific model task. The network side device transmits AI model management indication, where the AI model management indication is configured to indicate a terminal in a specific user group to execute receiving information related to the specific model task, to complete the specific model task.

In the embodiments of the present disclosure, the specific operation includes executing a specific operation related to a specific model task. The network side device transmits AI model management indication, where the AI model management indication is configured to indicate a terminal in a specific user group to perform a specific operation related to a specific model task to complete the specific model task.

Where specific model tasks are as described earlier. The network side device transmits AI model management indication, where the AI model management indication is configured to indicate a terminal in a specific user group to perform a specific operation to complete the specific model task. The specific operation may include one or more operations to complete one or more specific model tasks.

In some implementations, in the case where there is multiple specific operations, the network side device can further transmit indication to the terminal to indicate the execution order of the multiple specific operations, to indicate the terminal to execute the multiple specific operations in the execution order, to complete one or more specific model tasks.

In some implementations, in the case where there is multiple specific model tasks, the network side device can further transmit indication to the terminal to indicate the completion order of the multiple specific model tasks, to indicate the terminal to execute specific operations corresponding to the specific model tasks in sequence according to the completion order, to complete the multiple specific model tasks in sequence.

In the embodiments of the present disclosure, specific operations and specific model tasks can be transmitted to the terminal in the form of a table, where the table includes specific operations corresponding to specific model tasks, or specific operations and their corresponding specific model tasks.

In some embodiments, when the specific model task includes the first task of activating the first model, the specific operation includes activating the first model; when the specific model task includes the second task of deactivating the second model, the specific operation includes deactivating the second model; when the specific model task includes the third task of switching to the third model, the specific operation includes switching to the third model; when the specific model task includes updating the fourth model, the specific operation includes updating the fourth model; when the specific model task includes the fifth task of falling back through a fifth model to a non-model operation, the specific operation includes falling back through a fifth model to a non-model operation.

In some embodiments, terminals in the same specific user group have the same characteristics, where the same characteristics include at least one of the following:
being in a same scenario;
being in a same sector; or
being in a same cell.

In the embodiments of the present disclosure, terminals in the same specific user group can be in the same scenario, such as in the same geographical region (indoor factory, or indoor office, etc.).

In the embodiments of the present disclosure, terminals in the same specific user group can be in the same sector.

In the embodiments of the present disclosure, terminals in the same specific user group can be located in the same cell.

It can be understood that the network side device can transmit an AI model management indication to terminals from different user groups to indicate them to perform the same or different specific operations to complete same or different specific model tasks.

Where when grouping terminals, they can be grouped based on model tasks and/or operations. Different user groups correspond to different model tasks and/or operations, such as a user group that shares the same indication of activating or deactivating the model, and a user group that shares the indication of updating the model.

In the embodiments of the present disclosure, for specific model management operations, there may be different user groups. For example, the user group sharing the same indication of activating or deactivating the model and the user group sharing the indication of updating the model are different.

In some embodiments, the AI model management indication includes at least one of the following:
a first indication, where the first indication is configured to indicate a terminal in a first user group to perform a specific operation to complete the first task of activating the first model;
a second indication, where the second indication is configured to indicate a terminal in a second user group to perform a specific operation to complete the second task of deactivating the second model;
a third indication, where the third indication is configured to indicate a terminal in a third user group to perform a specific operation to complete the third task of switching to the third model;
a fourth indication, where the fourth indication is configured to indicate a terminal in a fourth user group to perform a specific operation to complete the fourth task of updating the fourth model; or
a fifth indication, where the fifth indication is configured to indicate a terminal in a fifth user group to perform a specific operation to complete the fifth task of falling back through the fifth model to the non-model operation.

In some embodiments, any two of the first indication, the second indication, the third indication, the fourth indication, or the fifth indication are different from each other, or at least two of the first indication, the second indication, the third indication, the fourth indication, or the fifth indication are different from each other.

In the embodiments of the present disclosure, for different specific operations and/or different specific model tasks, different indication signaling is used for the AI model management indication. Any two of the first indication, the second indication, the third indication, the fourth indication, or the fifth indication are different from each other, or at least two of the first indication, the second indication, the third indication, the fourth indication, or the fifth indication are different from each other.

For example, the first indication and the second indication may be transmitted via a group common PDCCH, and the fourth indication may be transmitted via a multicast channel.

In some embodiments, the network side device transmits the AI model management indication, including:
in response to presence of a plurality of user groups in a cell, transmitting, via one shared channel, the AI model management indication to terminals from different user groups; or
in response to presence of a plurality of user groups in a cell, transmitting, via separate channels, the AI model management indication respectively to terminals from different user groups.

In the embodiments of the present disclosure, the network side device transmits the AI model management indication. When there are multiple user groups in the cell, the AI model management indication can be transmitted to terminals from different user groups via one shared channel.

In the embodiments of the present disclosure, the network side device transmits the AI model management indication. When there are multiple user groups in the cell, the AI model management indication can be transmitted to terminals from different user groups respectively via separate channels.

In some embodiments, in response to transmitting, via one shared channel, the AI model management indication to the terminals from the different user groups, before transmitting the AI model management indication, the network side device transmits an information field indication to the terminals from the different user groups, where the information field indication is configured to indicate different information fields in the shared channel in which the terminals from the different user groups receive the AI model management indication.

In the embodiments of the present disclosure, when the network side device transmits the AI model management indication to the terminals from the different user groups via one shared channel, before transmitting the AI model management indication, the network side device can transmit an information field indication to the terminals from the different user groups, where the information field indication is configured to indicate different information fields in the shared channel in which the terminals from the different user groups receive the AI model management indication.

Based on this, the information field indication can indicate the specific information field(s) in the shared channel corresponding to the specific user group to which the terminal(s) belongs. The terminal(s) can receive the AI model management indication in the specific information field(s) indicated by the network side device.

Through the implementation of the present disclosure, the network side device transmits the AI model management indication, where the AI model management indication is configured to indicate terminals in a specific user group to perform specific operations to complete specific model tasks. Therefore, the management of AI models for multiple terminals simultaneously is supported, which can improve the efficiency of model management.

Referring to FIG. 3, FIG. 3 is a flowchart of another model management method provided in the embodiments of the present disclosure. As shown in FIG. 3, the method is performed by the network side device, and the method may include but is not limited to the following step S31.

In S31, an information field indication is transmitted to the terminals from the different user groups, where the information field indication is configured to indicate different information fields in the shared channel in which the terminals from the different user groups receive the AI model management indication.

In the embodiments of the present disclosure, the network side device can transmit an information field indication to terminals from different user groups, where the information field indication is configured to indicate different information fields in the shared channel in which the terminals from the different user groups receive the AI model management indication. Therefore, the terminal can determine to receive the AI model management indication transmitted by the network side device in the information field indicated by the information field indication.

For example, the network side device can transmit any one of the following: physical downlink control channel (PDCCH), physical downlink shared channel (PDSCH), radio resource control (RRC), media access control control element (MAC CE), or downlink control information (DCI), etc., where any one of the PDCCH, PDSCH, RRC, MAC CE, or DCI, etc., carries the information field indication.

In the embodiments of the present disclosure, the information field indication is implemented based on the common indication. That is, one or more terminals in the user group monitor the common indication together. The common indication is the same for the terminals in a user group, indicating the information field(s) in which the terminals in the user group receive the AI model management indication.

In the embodiments of the present disclosure, the information field indication may carry user group identifiers and the information field identifiers corresponding to the user group identifiers, to indicate different information fields in the shared channel in which the different user groups receive the AI model management indication.

It can be understood that before the network side device transmits the information field indication, the network side device can further receive the user group information (such as the user group identifier) reported by the terminal, to distinguish the terminals of different user groups. Based on this, the network side device can transmit an information field indication to indicate the specific information field in the shared channel corresponding to the specific user group to which the terminal belongs.

In the embodiments of the present disclosure, the AI model management indication is configured to indicate a terminal in a specific user group to perform a specific operation to complete a specific model task. The relevant description of the AI model management indication can be found in the above embodiments and will not be repeated here.

It should be noted that in the embodiments of the present disclosure, S31 can be implemented separately or in combination with any other step in the embodiments of the present disclosure, such as in combination with S21 in the embodiments of the present disclosure, which is not limited by the embodiments of the present disclosure.

By implementing the embodiments of the present disclosure, the network side device transmits an information field indication to terminals in different user groups, where the information field indication is configured to indicate different information fields in the shared channel in which the terminals from the different user groups receive the AI model management indication. Thus, terminals can receive the AI model management indication in the information fields indicated by the information field indication, to perform the specific operation to complete the specific model task based on the AI model management indication, which can improve model management efficiency.

Referring to FIG. 4, FIG. 4 is a flowchart of another model management method provided in the embodiments of the present disclosure. As shown in FIG. 4, the method is performed by the terminal, and the method may include but is not limited to the following step S41.

In S41, an AI model management indication transmitted by a network side device is received, where the AI model management indication is configured to indicate the terminal in a specific user group to perform a specific operation to complete a specific model task.

In the embodiments of the present disclosure, the terminal can receive an AI model management indication transmitted by the network side device, where the terminal can receive the AI model management indication transmitted by the network side device through broadcasting, or can also receive the AI model management indication transmitted by the network side device through multicast or unicast.

For example, the terminal may receive any one of the following transmitted by the network side device: physical downlink control channel (PDCCH), physical downlink shared channel (PDSCH), radio resource control (RRC), media access control control element (MAC CE), or downlink control information (DCI), etc., where any one of the PDCCH, PDSCH, RRC, MAC CE, or DCI, etc., carries the AI model management indication.

In the embodiments of the present disclosure, the AI model management indication is implemented based on the common indication. That is, one or more terminals in the user group monitor the common indication together. The common indication for model management of terminals in the user group is the same, instructing the terminals in the user group to perform the same specific operations to complete the same specific model tasks.

Where the AI model management indication is configured to indicate terminals in a specific user group to perform specific operations to complete specific model tasks.

In some implementations, the AI model management indication can carry a user group identifier to indicate the specific user group.

For example, the network side device transmits the AI model management indication, where the AI model management indication carries a user group identifier. After receiving the AI model management indication transmitted by the network side device, the terminal can compare the user group to which the terminal belongs with the user group identifier carried by the AI model management indication. If the user group to which the terminal belongs corresponds to the user group identifier, the terminal determines to perform the specific operation indicated by the AI model management indication to complete the specific model task.

It can be understood that before the network side device transmits the AI model management indication, the network side device can further receive the user group information (such as the user group identifier) reported by the terminal, to distinguish the terminals of different user groups. Based on this, the network side device can transmit the AI model management indication to indicate a terminal in a specific user group to perform a specific operation to complete a specific model task.

In the embodiments of the present disclosure, the user group may include one or more terminals.

In some implementations, the AI model management indication can carry a task identifier to indicate a terminal in a specific user group to perform a specific operation, to complete a specific model task corresponding to the task identifier.

In some embodiments, the specific model task includes at least one of the following:
a first task of activating a first model;
a second task of deactivating a second model;
a third task of switching to a third model;
a fourth task of updating a fourth model; or
a fifth task of falling back through a fifth model to a non-model operation.

In the embodiment of the present disclosure, the specific model task includes the first task of activating the first model. The terminal can receive the AI model management indication transmitted by the network side device, where the AI model management indication is configured to indicate a terminal in a specific user group to perform a specific operation to complete the first task of activating the first model.

Where the first model can be obtained by training at the terminal or network side device. In the case that the first model is obtained by training at the network side device, the terminal can receive the first model transmitted by the network side device in advance before receiving the AI model management indication transmitted by the network side device. When the first model is obtained through training at the terminal, the terminal can report the model information to the network side device. The model information indicates that the terminal is configured with the trained first model, and the network side device can transmit the AI model management indication to the terminal to indicate the terminal to perform a specific operation to complete the first task of activating the first model according to the model information.

In the embodiment of the present disclosure, the specific model task includes the second task of deactivating the second model. The terminal can receive the AI model management indication transmitted by the network side device, where the AI model management indication is configured to indicate the terminal in a specific user group to perform a specific operation to complete the second task of deactivating the second model.

Where the second model can be obtained by training at the terminal or network side device. In the case that the second model is obtained by training at the network side device, the terminal can receive the second model transmitted by the network side device in advance before receiving the AI model management indication transmitted by the network side device. When the second model is obtained through training at the terminal, the terminal can report the model information to the network side device. The model information indicates that the terminal is configured with the trained second model, and the network side device can transmit the AI model management indication to the terminal to indicate the terminal to perform a specific operation to complete the second task of deactivating the second model according to the model information.

In the embodiment of the present disclosure, the specific model task includes the third task of switching to the third model. The terminal can receive the AI model management indication transmitted by the network side device, where the AI model management indication is configured to indicate the terminal in a specific user group to perform a specific operation to complete the third task of switching to the third model.

Where the third model can be obtained by training at the terminal or network side device. In the case that the third model is obtained by training at the network side device, the terminal can receive the third model transmitted by the network side device in advance before receiving the AI model management indication transmitted by the network side device. When the third model is obtained through training at the terminal, the terminal can report the model information to the network side device. The model information indicates that the terminal is configured with the trained third model, and the network side device can transmit the AI model management indication to the terminal to indicate the terminal to perform a specific operation to complete the third task of switching to the third model according to the model information.

In the embodiments of the present disclosure, the specific model task includes the fourth task of updating the fourth model. The terminal can receive the AI model management indication transmitted by the network side device, where the AI model management indication is configured to indicate a terminal in a specific user group to perform a specific operation to complete the fourth task of updating the fourth model.

Where the fourth model can be obtained by training at the terminal or network side device. In the case that the fourth model is obtained by training at the network side device, the terminal can receive the fourth model transmitted by the network side device in advance before receiving the AI model management indication transmitted by the network side device. When the fourth model is obtained through training at the terminal, the terminal can report the model information to the network side device. The model information indicates that the terminal is configured with the trained fourth model, and the network side device can transmit the AI model management indication to the terminal to indicate the terminal to perform a specific operation to complete the fourth task of updating the fourth model according to the model information.

In the embodiments of the present disclosure, the specific model task includes the fifth task of falling back through the fifth model to a non-model operation. The terminal can receive the AI model management indication transmitted by the network side device, where the AI model management indication is configured to indicate a terminal in a specific user group to perform a specific operation to complete the fifth task of falling back through the fifth model to a non-model operation.

Where the fifth model can be obtained by training at the terminal or network side device. In the case that the fifth model is obtained by training at the network side device, the terminal can receive the fifth model transmitted by the network side device in advance before receiving the AI model management indication transmitted by the network side device. When the fifth model is obtained through training at the terminal, the terminal can report the model information to the network side device. The model information indicates that the terminal is configured with the trained fifth model, and the network side device can transmit the AI model management indication to the terminal to indicate the terminal to perform a specific operation to complete the fifth task of falling back through the fifth model to a non-model operation, according to the model information.

In some embodiments, at least two of the first model, the second model, the third model, the fourth model, or the fifth model are the same, or any two of the first model, the second model, the third model, the fourth model, or the fifth model are different from each other.

In some embodiments, the specific operation includes at least one of the following:
transmitting a reference signal related to the specific model task;
feedbacking information related to the specific model task;
receiving information related to the specific model task; or
performing a specific operation related to the specific model task.

In the embodiments of the present disclosure, the specific operation includes transmitting a reference signal related to the specific model task. The terminal can receive the AI model management indication transmitted by the network side device, where the AI model management indication is configured to indicate a terminal in a specific user group to execute transmitting a reference signal related to the specific model task, to complete the specific model task.

In the embodiments of the present disclosure, the specific operation includes feedbacking information related to the specific model task. The terminal can receive the AI model management indication transmitted by the network side device, where the AI model management indication is configured to indicate a terminal in a specific user group to execute feedbacking information related to the specific model task, to complete the specific model task.

In the embodiments of the present disclosure, the specific operation includes receiving information related to the specific model task. The terminal can receive the AI model management indication transmitted by the network side device, where the AI model management indication is configured to indicate a terminal in a specific user group to execute receiving information related to the specific model task, to complete the specific model task.

In the embodiments of the present disclosure, the specific operation includes executing a specific operation related to a specific model task. The terminal can receive the AI model management indication transmitted by the network side device, where the AI model management indication is configured to indicate a terminal in a specific user group to perform a specific operation related to a specific model task to complete the specific model task.

Where specific model tasks are as described earlier. The terminal can receive the AI model management indication transmitted by the network side device, where the AI model management indication is configured to indicate a terminal in a specific user group to perform a specific operation to complete the specific model task. The specific operation may include one or more operations to complete one or more specific model tasks.

In some implementations, in the case where there are multiple specific operations, the terminals can further receive an indication transmitted by the network side device to determine the execution order of the multiple specific operations, to execute the multiple specific operations in the execution order and complete one or more specific model tasks.

In some implementations, in the case where there is multiple specific model tasks, the terminals can further receive an indication transmitted by the network side device to determine the completion order of multiple specific model tasks, to execute specific operations corresponding to specific model tasks in sequence according to the completion order, to complete multiple specific model tasks in sequence.

In the embodiments of the present disclosure, specific operations and specific model tasks can be transmitted to the terminal in the form of a table, where the table includes specific operations corresponding to specific model tasks, or specific operations and their corresponding specific model tasks.

In some embodiments, when the specific model task includes the first task of activating the first model, the specific operation includes activating the first model; when the specific model task includes the second task of deactivating the second model, the specific operation includes deactivating the second model; when the specific model task includes the third task of switching to the third model, the specific operation includes switching to the third model; when the specific model task includes updating the fourth model, the specific operation includes updating the fourth model; when the specific model task includes the fifth task of falling back through a fifth model to a non-model operation, the specific operation includes falling back through a fifth model to a non-model operation.

In some embodiments, terminals in the same specific user group have the same characteristics, where the same characteristics include at least one of the following:
being in a same scenario;
being in a same sector; or
being in a same cell.

In the embodiments of the present disclosure, terminals in the same specific user group can be in the same scenario, such as in the same geographical region (indoor factory, or indoor office, etc.).

In the embodiments of the present disclosure, terminals in the same specific user group can be in the same sector.

In the embodiments of the present disclosure, terminals in the same specific user group can be located in the same cell.

It can be understood that the network side device can transmit AI model management indication to terminals of different user groups to indicate them to perform the same or different specific operations to complete same or different specific model tasks.

Where when grouping terminals, they can be grouped based on model tasks and/or operations. Different user groups correspond to different model tasks and/or operations, such as a user group that shares the same indication of activating or deactivating the model, and a user group that shares the indication of updating the model.

In the embodiments of the present disclosure, for specific model management operations, there may be different user groups. For example, the user group sharing the same indication of activating or deactivating the model and the user group sharing the indication of updating the model are different.

In some embodiments, the AI model management indication includes at least one of the following:
a first indication, where the first indication is configured to indicate a terminal in a first user group to perform a specific operation to complete the first task of activating the first model;
a second indication, where the second indication is configured to indicate a terminal in a second user group to perform a specific operation to complete the second task of deactivating the second model;
a third indication, where the third indication is configured to indicate a terminal in a third user group to perform a specific operation to complete the third task of switching to the third model;
a fourth indication, where the fourth indication is configured to indicate a terminal in a fourth user group to perform a specific operation to complete the fourth task of updating the fourth model; or
a fifth indication, where the fifth indication is configured to indicate a terminal in a fifth user group to perform a specific operation to complete the fifth task of falling back through the fifth model to the non-model operation.

In some embodiments, any two of the first indication, the second indication, the third indication, the fourth indication, or the fifth indication are different from each other, or at least two of the first indication, the second indication, the third indication, the fourth indication, or the fifth indication are different from each other.

In the embodiments of the present disclosure, for different specific operations and/or different specific model tasks, different indication signaling is used for AI model management indication. Any two of the first indication, the second indication, the third indication, the fourth indication, or the fifth indication are different from each other, or at least two of the first indication, the second indication, the third indication, the fourth indication, or the fifth indication are different from each other.

For example, the first indication and the second indication may be transmitted via a group common PDCCH, and the fourth indication may be transmitted via a multicast channel.

In some embodiments, the terminals receive an information field indication transmitted by the network side device, where the information field indication is configured to indicate different information fields in one shared channel in which terminals from different user groups receive the AI model management indication.

In the embodiments of the present disclosure, the terminals can further receive an information field indication transmitted by the network side device, where the information field indication is configured to indicate different information fields in one shared channel in which terminals from different user groups receive the AI model management indication. Thus, the information field indication can indicate the specific information field in the same shared channel corresponding to the specific user group to which the terminal belongs. Based on the information field indication, the terminal can determine the specific information field in the same shared channel to receive the AI model management indication, to receive the AI model management indication in the specific information field indicated by the network side device.

Through the implementation of the present disclosure, terminals receive an AI model management indication transmitted by the network side device, where the AI model management indication is configured to indicate terminals in a specific user group to perform specific operations to complete specific model tasks. Therefore, the management of AI models for multiple terminals simultaneously is supported, which can improve the efficiency of model management.

Referring to FIG. 5, FIG. 5 is a flowchart of another model management method provided in the embodiments of the present disclosure. As shown in FIG. 5, the method is performed by the terminal, and the method may include but is not limited to the following step S51.

In S51, an information field indication transmitted by the network side device is received, where the information field indication is configured to indicate different information fields in one shared channel in which terminals from different user groups receive the AI model management indication.

In the embodiments of the present disclosure, the terminals can receive an information field indication transmitted by the network side device, where the information field indication is configured to indicate different information fields in one shared channel in which terminals from different user groups receive the AI model management indication. Thus, the information field indication can indicate the specific information field in the same shared channel corresponding to the specific user group to which the terminal belongs. Based on the information field indication, the terminal can determine the specific information field in the same shared channel to receive the AI model management indication, to receive the AI model management indication in the specific information field indicated by the network side device.

For example, the terminal may receive any one of the following transmitted by the network side device: physical downlink control channel (PDCCH), physical downlink shared channel (PDSCH), radio resource control (RRC), media access control control element (MAC CE), or downlink control information (DCI), etc., where any one of the PDCCH, PDSCH, RRC, MAC CE, or DCI, etc., carries the information field indication.

In the embodiments of the present disclosure, the information field indication is implemented based on the common indication. That is, one or more terminals in the user group monitor the common indication together. The common indication is the same for the terminals in a user group, indicating the information fields in which the terminals in the user group receive the AI model management indication.

In the embodiments of the present disclosure, the information field indication may carry user group identifiers and the information field identifiers corresponding to the user group identifiers, to indicate different information fields in the shared channel in which the different user groups receive the AI model management indication.

It can be understood that before receiving the information field indication transmitted by the network side device, the terminal can further report user group information to the network side device, such as reporting the user group identifier, such that the network side device can distinguish terminals of different user groups. Based on this, the network side device can transmit the information field indication to indicate the specific information field in the shared channel corresponding to the specific user group to which the terminal belongs.

In the embodiments of the present disclosure, the AI model management indication is configured to indicate a terminal in a specific user group to perform a specific operation to complete a specific model task. The relevant description of the AI model management indication can be found in the above embodiments and will not be repeated here.

It should be noted that in the embodiments of the present disclosure, S51 can be implemented separately or in combination with any other step in the embodiments of the present disclosure, such as in combination with S41 in the embodiments of the present disclosure, which is not limited by the embodiments of the present disclosure.

Through the embodiments of the present disclosure, the terminals receive an information field indication transmitted by the network side device, where the information field indication is configured to indicate different information fields in one shared channel in which terminals from different user groups receive the AI model management indication. Thus, terminals can receive the AI model management indication in the information fields indicated by the information field indication, to perform the specific operation to complete the specific model task based on the AI model management indication, which can improve model management efficiency.

In the embodiments provided in the present disclosure, the methods provided in the embodiments of the present disclosure are introduced from the perspectives of the network side device and the terminal.

Referring to FIG. 6, FIG. 12 is a schematic structural diagram of a communication apparatus 1 provided in the embodiments of the present disclosure. The communication device 1 shown in FIG. 6 may include a transceiver module 11 and a processing module. The transceiver module can include a transmitting module and/or a receiving module. The transmitting module is configured to achieve a transmitting function, the receiving module is configured to achieve a receiving function, and the transceiver module can achieve the transmitting and/or receiving functions.

The communication apparatus 1 can be a terminal, a device in the terminal, or a device that can be matched and used with the terminal. Alternatively, the communication apparatus 1 can be a network side device, a device in a network side device, or a device that can be matched and used with the network side device.

The communication apparatus 1 is configured on the network side device.

The apparatus includes a transceiver module 11.

The transceiver module 11 is configured to transmit artificial intelligence (AI) model management indication, where the AI model management indication is configured to indicate a terminal in a specific user group to perform a specific operation to complete a specific model task.

In some embodiments, the specific model task includes at least one of the following:
a first task of activating a first model;
a second task of deactivating a second model;
a third task of switching to a third model;
a fourth task of updating a fourth model; or
a fifth task of falling back through a fifth model to a non-model operation.

In some embodiments, the specific operation includes at least one of the following:
transmitting a reference signal related to the specific model task;
feedbacking information related to the specific model task;
receiving information related to the specific model task; or
performing a specific operation related to the specific model task.

In some embodiments, when the specific model task includes a first task of activating a first model, the specific operation includes activating the first model;
when the specific model task includes a second task of deactivating a second model, the specific operation includes deactivating the second model;
when the specific model task includes a third task of switching to a third model, the specific operation includes switching to the third model;
when the specific model task includes a fourth task of updating a fourth model, the specific operation includes updating the fourth model;
when the specific model task includes a fifth task of falling back through a fifth model to a non-model operation, the specific operation includes falling back through the fifth model to the non-model operation.

In some embodiments, terminals in the same specific user group have the same characteristics, where the same characteristics include at least one of the following:
being in a same scenario;
being in a same sector; or
being in a same cell.

In some embodiments, the AI model management indication includes at least one of the following:
a first indication, where the first indication is configured to indicate a terminal in a first user group to perform a specific operation to complete the first task of activating the first model;
a second indication, where the second indication is configured to indicate a terminal in a second user group to perform a specific operation to complete the second task of deactivating the second model;
a third indication, where the third indication is configured to indicate a terminal in a third user group to perform a specific operation to complete the third task of switching to the third model;
a fourth indication, where the fourth indication is configured to indicate a terminal in a fourth user group to perform a specific operation to complete the fourth task of updating the fourth model; or
a fifth indication, where the fifth indication is configured to indicate a terminal in a fifth user group to perform a specific operation to complete the fifth task of falling back through the fifth model to the non-model operation.

In some embodiments, any two of the first indication, the second indication, the third indication, the fourth indication, or the fifth indication are different from each other, or at least two of the first indication, the second indication, the third indication, the fourth indication, or the fifth indication are different from each other.

In some embodiments, the transceiver module 11 is further configured to: in response to the presence of multiple user groups in the cell, transmit the AI model management indication to terminals of different user groups via the same shared channel; or in response to the presence of multiple user groups in the cell, transmit the AI model management indication to terminals from different user groups respectively via separate channels.

In some embodiments, the transceiver module 11 is further configured to: in response to transmitting, via one shared channel, the AI model management indication to the terminals from the different user groups, before transmitting the AI model management indication, transmit information field indication to the terminals of the different user groups, where the information field indication is configured to indicate different information fields in the shared channel in which the terminals from the different user groups receive the AI model management indication.

The communication device 1 is configured on the terminal.

The apparatus includes a transceiver module 11.

The transceiver module 11 is configured to receive an AI model management indication transmitted by a network side device, where the AI model management indication is configured to indicate the terminal in a specific user group to perform a specific operation to complete a specific model task.

In some embodiments, the specific model task includes at least one of the following:
a first task of activating a first model;
a second task of deactivating a second model;
a third task of switching to a third model;
a fourth task of updating a fourth model; or
a fifth task of falling back through a fifth model to a non-model operation.

In some embodiments, the specific operation includes at least one of the following:
transmitting a reference signal related to the specific model task;
feedbacking information related to the specific model task;
receiving information related to the specific model task; or
performing a specific operation related to the specific model task.

In some embodiments, when the specific model task includes a first task of activating a first model, the specific operation includes activating the first model;
when the specific model task includes a second task of deactivating a second model, the specific operation includes deactivating the second model;
when the specific model task includes a third task of switching to a third model, the specific operation includes switching to the third model;
when the specific model task includes a fourth task of updating a fourth model, the specific operation includes updating the fourth model;
when the specific model task includes a fifth task of falling back through a fifth model to a non-model operation, the specific operation includes falling back through the fifth model to the non-model operation.

In some embodiments, terminals in the same specific user group have the same characteristics, where the same characteristics include at least one of the following:
being in a same scenario;
being in a same sector; or
being in a same cell.

In some embodiments, the AI model management indication includes at least one of the following:
a first indication, where the first indication is configured to indicate a terminal in a first user group to perform a specific operation to complete the first task of activating the first model;
a second indication, where the second indication is configured to indicate a terminal in a second user group to perform a specific operation to complete the second task of deactivating the second model;
a third indication, where the third indication is configured to indicate a terminal in a third user group to perform a specific operation to complete the third task of switching to the third model;
a fourth indication, where the fourth indication is configured to indicate a terminal in a fourth user group to perform a specific operation to complete the fourth task of updating the fourth model; or
a fifth indication, where the fifth indication is configured to indicate a terminal in a fifth user group to perform a specific operation to complete the fifth task of falling back through the fifth model to the non-model operation.

In some embodiments, any two of the first indication, the second indication, the third indication, the fourth indication, or the fifth indication are different from each other, or
at least two of the first indication, the second indication, the third indication, the fourth indication, or the fifth indication are different from each other.

In some embodiments, the transceiver module 11 is further configured to receive an information field indication transmitted by the network side device, where the information field indication is configured to indicate different information fields in one shared channel in which terminals from different user groups receive the AI model management indication.

Regarding the communication apparatus 1 in the above examples, the specific manner in which each module performs operations has been described in detail in the examples of the methods, and will not be described in detail here.

The communication device 1 provided in the above embodiments of the present disclosure achieves the same or similar beneficial effects as the model management methods provided in some of the above embodiments, which will not be repeated here.

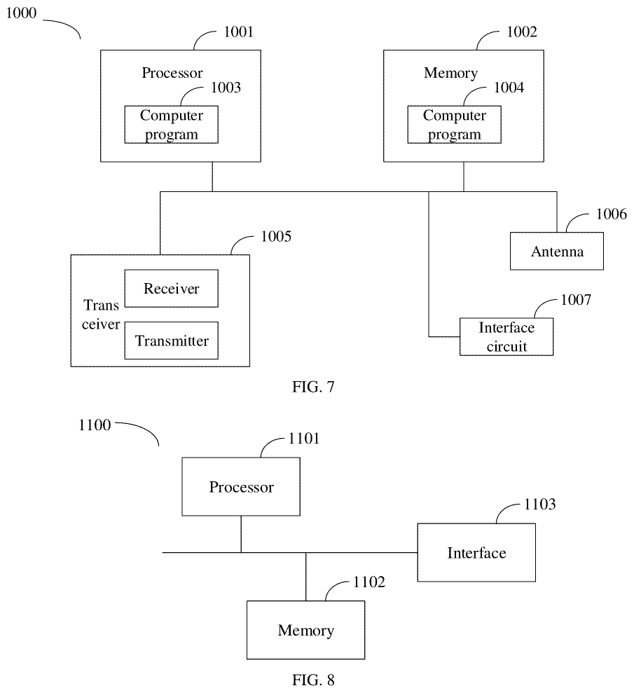

Referring to FIG. 7, FIG. 7 is a schematic structural diagram of another communication device 1000 provided in the embodiments of the present disclosure. The communication device 1000 can be a terminal, a network side device, a chip, a chip system, or a processor that supports the embodiment of the above method implemented by a terminal, and can also be a chip, a chip system, or a processor that supports the embodiment of the above method implemented by a network side device. The communication device 1000 can be configured to implement the methods described in the above method embodiments, as described in the above method embodiments.

The communication device 1000 can include one or more processors 1001. The processor 1001 can be a general-purpose processor or a dedicated processor, etc. For example, the processor 181 can be a baseband processor or a central processing unit. The baseband processor can be used to process communication protocols and communication data, while the central processor can be used to control communication devices (such as network side devices, baseband chips, terminals, terminal chips, DU or CU, etc.), execute computer programs, and process computer program data.

In an embodiment, the communication device 1000 may further include one or more memories 1002, on which a computer program 1004 may be stored, and the memory 1002 may execute the computer program 1004 to enable the communication device 1000 to execute the method described in the above embodiments. In an embodiment, the memory 1002 may further store data. The communication device 1000 and memory 1002 can be set separately or integrated together.

In an embodiment, the communication device 1000 may also include a transceiver 1005 and an antenna 1006. The transceiver 1005 can be referred to as a transceiver unit, transceiver machine, or transceiver circuit, etc., used to achieve transceiver functions. The transceiver 1005 can include a receiving terminal and a transmitter, and the receiving terminal can be referred to as a receiving machine or a receiving circuit, etc., to achieve receiving functions. A transmitter can be referred to as a transmitting machine or a transmission circuit, etc., used to achieve transmission functions.

In an embodiment, the communication device 1000 may further include one or more interface circuits 1007. Interface circuit 1007 is configured to receive code instructions and transmit them to processor 1001. The processor 1001 runs the code instructions to cause the communication device 1000 to execute the method described in the above method embodiment.

The communication device 1000 is a network side device: transceiver 1005 is configured to execute S21 in FIG. 2, and S31 in FIG. 3.

The communication device 1000 is a terminal: transceiver 1005 is configured to execute S41 in FIG. 4, and S51 in FIG. 5.

In an embodiment, the processor 1001 can include a transceiver for implementing reception and transmission functions. For example, the transceiver can be a transceiver circuit, an interface, or an interface circuit. The transceiver circuit, interface, or interface circuit used to achieve receiving and transmitting functions can be separate or integrated together. The above-mentioned transceiver circuit, interface or interface circuit can be used for reading and writing code/data, or the above-mentioned transceiver circuit, interface or interface circuit can be used for signal transmission or transmission.

In an embodiment, the processor 1001 may store a computer program 1003. The computer program 1003 runs on the processor 1001 to enable the communication device 1000 to execute the method described in the above embodiments. The computer program 1003 may be embedded in processor 1001, where the processor 1001 may be implemented by hardware.

In an embodiment, the communication device 1000 can include a circuit that can perform the functions of transmitting, receiving, or communicating as described in the aforementioned method embodiments. The processor and transceiver described in the present disclosure can be implemented on integrated circuits (ICs), analog ICs, RF integrated circuits (RFICs), mixed signal ICs, application specific integrated circuits (ASICs), printed circuit boards (PCBs), electronic devices, or the like. The processor and transceiver can also be manufactured using various IC process technologies, such as complementary metal oxide semiconductor (CMOS), nMetal oxide semiconductor (NMOS), positive channel metal oxide semiconductor (PMOS), bipolar junction transistor (BJT), bipolar CMOS (BiCMOS), silicon germanium (SiGe), or gallium arsenide (GaAs), etc.

The communication device described in the above embodiments may be a terminal or network side device, but the scope of the communication device described in the present disclosure is not limited to this, and the structure of the communication device may not be limited by FIG. 7. The communication device can be a independent device or can be part of a larger device. For example, the communication device may be:
(1) Independent integrated circuit (IC), or a chip, or a chip system or a subsystem;
(2) A set of one or more ICs, which may optically further include a storage component for storing data or a computer program;
(3) ASICs, such as modems;
(4) Modules that can be embedded in other devices;
(5) Receiver, terminal, intelligent terminal, cellular phone, wireless device, handheld device, mobile unit, vehicle mounted device, net work side device, cloud device, or artificial intelligence device, etc;
(6) Others and so on.

For the case where the communication device can be a chip or a chip system, Referring to FIG. 8, FIG. 14 is a structural diagram of a chip provided in the embodiments of the present disclosure.

The chip 1100 includes a processor 1101 and an interface 1103. The number of processors 1101 can be one or more, and the number of interfaces 1103 can be multiple.

For the case where the chip is configured to implement the functions of the terminal in the embodiments of the present disclosure.

Interface 1103 is configured to receive code instructions and transmit the code indication to the processor.

Processor 1101 is configured to run code instructions to execute the model management method as described in some embodiments above.

For the case where the chip is configured to implement the functions of the network side device in the embodiments of the present disclosure.

Interface 1103 is configured to receive code instructions and transmit the code indication to the processor.

Processor 1101 is configured to run code instructions to execute the model management method as described in some embodiments above.

In some embodiments, the chip 1100 also includes a memory 1102, which is configured to store necessary computer programs and data.

Those skilled in the art can also understand that the various illustrative logical blocks and steps listed in the embodiments of the present disclosure can be implemented through electronic hardware, computer software, or a combination of both. Whether such functionality is implemented through hardware or software depends on the specific application and overall system design requirements. Those skilled in the art may use various methods to implement the described functions for each specific application, but such implementation should not be understood as exceeding the scope of protection in the embodiments of the present disclosure.

The embodiments of the present disclosure also provides a model management system, which includes a communication apparatus as a terminal and a communication apparatus as a network device in the aforementioned embodiment of FIG. 6, or includes a communication device as a terminal and a communication device as a network device in the aforementioned embodiment of FIG. 7.

The present disclosure further provides a readable storage medium on which instructions are stored, and when the instructions are performed by a computer, the functions of any one of the above method embodiments are implemented.

The present disclosure further provides a computer program product that implements the functions of any one of the above method embodiments when performed by a computer.

The above embodiments can be fully or partially implemented through software, hardware, firmware, or any combination thereof. When implemented using software, all or part of the steps can be implemented in the form of a computer program product. The computer program product includes one or more computer programs. When loading and executing the computer program on the computer, all or part of the processes or functions described in the embodiments of the present disclosure are generated. The computer can be a general-purpose computer, a specialized computer, a computer network, or other programmable devices. The computer program can be stored in a computer-readable storage medium or transmitted from one computer-readable storage medium to another. For example, the computer program can be transmitted from one website site, computer, server, or data center to another via wired (such as coaxial cable, fiber optic, digital subscriber line (DSL)) or wireless (such as infrared, wireless, microwave, etc.) manners. The computer-readable storage medium can be any available medium that the computer can access, or a data storage device such as a server, data center, etc. that integrates one or more available media. The available medium can be a magnetic medium (such as floppy disk, hard disk, magnetic tape), optical medium (such as high-density digital video disc (DVD)), or semiconductor medium (such as solid state disk (SSD)), etc.

Those skilled in the art can understand that the first, second, and other numerical numbers involved in the present disclosure are only for the convenience of description and differentiation, and are not used to limit the scope of the embodiments of the present disclosure, and also do not indicate sequential ordering.

“At least one” in the present disclosure can also be described as one or more, and multiple can be two, three, four, or more, without limitation in the present disclosure. In embodiments of the present disclosure, for a technical feature, the technical features described in “first”, “second”, “third”, “A”, “B”, “C”, and “D” are distinguished, and there is no sequential ordering or magnitude ordering between the technical features described in “first”, “second”, “third”, “A”, “B”, “C”, and “D”.

Depending on the context, the word “if” as used herein can be interpreted as “at the time of”, “when” or “in response to determining”.

The corresponding relationships shown in each table in the present disclosure can be configured or predefined. The values of the information in each table are only examples and can be configured to other values, which is not limited in the present disclosure. When configuring the correspondence between information and various parameters, it is not necessary to configure all the correspondence shown in each table. For example, in the table of the present disclosure, the corresponding relationships shown in certain rows may not be configured. For example, appropriate deformation adjustments can be made according to the above table, such as splitting, merging, etc. The names of the parameters shown in the titles of the above tables can also use other names that can be understood by the communication device, and the values or representations of their parameters can also be understood by other values or representations that can be understood by the communication device. When implementing the above tables, other data structures can also be used, such as arrays, queues, containers, stacks, linear tables, pointers, linked lists, trees, graphs, structures, classes, heaps, hash tables, or hash tables.

The predefined terms in the present disclosure can be understood as defined, defined in advance, stored, pre-stored, pre-negotiated, pre-configured, solidified, or pre-fired.

Those skilled in the art can realize that the units and algorithm steps of each example described in the embodiments of the present disclosure can be implemented in electronic hardware, or a combination of computer software and electronic hardware. Whether these functions are executed in hardware or software depends on the specific application and design constraints of the technical solution. Those skilled in the art may use different methods to implement the described functions for each specific application, but such implementation should not be considered beyond the scope of the present disclosure.

Those skilled in the art can clearly understand that for the convenience and brevity of description, the specific working process of the above-described system, apparatus and unit can refer to the corresponding process in the foregoing method embodiments, which will not be repeated here.

The foregoing description is merely example embodiments of the present disclosure, but the scope of protection of the present disclosure is not limited thereto, and any variation or replacement readily conceivable by a person skilled in the art within the technical scope disclosed in the present disclosure should belong to the scope of protection of the present disclosure. Therefore, the scope of protection of the present disclosure should be based on the scope of protection of said claims.

1. A model management method, performed by a network side device, comprising:
transmitting an artificial intelligence (AI) model management indication, wherein the AI model management indication is configured to indicate a terminal in a specific user group to perform a specific operation to complete a specific model task.

2. The method according to claim 1, wherein the specific model task comprises at least one of:
a first task of activating a first model;
a second task of deactivating a second model;
a third task of switching to a third model;
a fourth task of updating a fourth model; or
a fifth task of falling back through a fifth model to a non-model operation.

3. The method according to claim 1, wherein the specific operation comprises at least one of:
transmitting a reference signal related to the specific model task;
feedbacking information related to the specific model task;
receiving information related to the specific model task; or
performing a specific operation related to the specific model task.

4. The method according to claim 3, wherein
when the specific model task comprises a first task of activating a first model, the specific operation comprises activating the first model;
when the specific model task comprises a second task of deactivating a second model, the specific operation comprises deactivating the second model;
when the specific model task comprises a third task of switching to a third model, the specific operation comprises switching to the third model;
when the specific model task comprises a fourth task of updating a fourth model, the specific operation comprises updating the fourth model;
when the specific model task comprises a fifth task of falling back through a fifth model to a non-model operation, the specific operation comprises falling back through the fifth model to the non-model operation.

5. The method according to claim 1, wherein terminals in one specific user group have same characteristics, wherein the same characteristics comprise at least one of:
being in a same scenario;
being in a same sector; or
being in a same cell.

6. The method according to claim 2, wherein the AI model management indication comprises at least one of:
a first indication, wherein the first indication is configured to indicate a terminal in a first user group to perform a specific operation to complete the first task of activating the first model;
a second indication, wherein the second indication is configured to indicate a terminal in a second user group to perform a specific operation to complete the second task of deactivating the second model;
a third indication, wherein the third indication is configured to indicate a terminal in a third user group to perform a specific operation to complete the third task of switching to the third model;
a fourth indication, wherein the fourth indication is configured to indicate a terminal in a fourth user group to perform a specific operation to complete the fourth task of updating the fourth model; or
a fifth indication, wherein the fifth indication is configured to indicate a terminal in a fifth user group to perform a specific operation to complete the fifth task of falling back through the fifth model to the non-model operation.

7. The method according to claim 6, wherein
any two of the first indication, the second indication, the third indication, the fourth indication, or the fifth indication are different from each other, or
at least two of the first indication, the second indication, the third indication, the fourth indication, or the fifth indication are different from each other.

8. The method according to claim 1, wherein transmitting the AI model management indication comprises:
in response to presence of a plurality of user groups in a cell, transmitting, via one shared channel, the AI model management indication to terminals from different user groups; or
in response to presence of a plurality of user groups in a cell, transmitting, via separate channels, the AI model management indication respectively to terminals from different user groups.

9. The method according to claim 8, further comprising:
in response to transmitting, via one shared channel, the AI model management indication to the terminals from the different user groups, before transmitting the Al model management indication, transmitting an information field indication to the terminals from the different user groups, wherein the information field indication is configured to indicate different information fields in the shared channel in which the terminals from the different user groups receive the AI model management indication.

10. A model management method, performed by a terminal, comprising:
receiving an AI model management indication transmitted by a network side device, wherein the AI model management indication is configured to indicate the terminal in a specific user group to perform a specific operation to complete a specific model task.

11. The method according to claim 10, wherein the specific model task comprises at least one of:
a first task of activating a first model;
a second task of deactivating a second model;
a third task of switching to a third model;
a fourth task of updating a fourth model; or
a fifth task of falling back through a fifth model to a non-model operation.

12. The method according to claim 10, wherein the specific operation comprises at least one of:
transmitting a reference signal related to the specific model task;
feedbacking information related to the specific model task;
receiving information related to the specific model task; or
performing a specific operation related to the specific model task.

13. The method according to claim 12, wherein
when the specific model task comprises a first task of activating a first model, the specific operation comprises activating the first model;
when the specific model task comprises a second task of deactivating a second model, the specific operation comprises deactivating the second model;
when the specific model task comprises a third task of switching to a third model, the specific operation comprises switching to the third model;
when the specific model task comprises a fourth task of updating a fourth model, the specific operation comprises updating the fourth model;
when the specific model task comprises a fifth task of falling back through a fifth model to a non-model operation, the specific operation comprises falling back through the fifth model to the non-model operation.

14. The method according claim 10, wherein terminals in one specific user group have same characteristics, wherein the same characteristics comprise at least one of:
being in a same scenario;
being in a same sector; or
being in a same cell.

15. The method according to claim 11, wherein the AI model management indication information comprises at least one of:
a first indication, wherein the first indication is configured to indicate the terminal in a first user group to perform a specific operation to complete the first task of activating the first model;
a second indication, wherein the second indication is configured to indicate the terminal in a second user group to perform a specific operation to complete the second task of deactivating the second model;
a third indication, wherein the third indication is configured to indicate the terminal in a third user group to perform a specific operation to complete the third task of switching to the third model;
a fourth indication, wherein the fourth indication is configured to indicate the terminal in a fourth user group to perform a specific operation to complete the fourth task of updating the fourth model; or
a fifth indication, wherein the fifth indication is configured to indicate the terminal in a fifth user group to perform a specific operation to complete the fifth task of falling back through the fifth model to the non-model operation.

16. The method according to claim 15, wherein
any two of the first indication, the second indication, the third indication, the fourth indication, or the fifth indication are different from each other, or
at least two of the first indication, the second indication, the third indication, the fourth indication, or the fifth indication are different from each other.

17. The method according to claim 10, further comprising:
receiving an information field indication transmitted by the network side device, wherein the information field indication is configured to indicate different information fields in one shared channel in which terminals from different user groups receive the Al model management indication.

18. (canceled)

19. (canceled)

20. A network side device, comprising:
one or more processors; and
one or more memories storing a computer program executable by the one or more processors;
wherein the one or more processors are configured to perform the method according to claim 1.

21. A terminal, comprising:
one or more processors; and
one or more memories, storing a computer program executable by the one or more processors;
wherein the one or more processors are configured to perform the method according to claim 10.

22. (canceled)

23. A non-transitory computer-readable storage medium storing instructions that, when executed by a processor, cause the processor to perform the method according to claim 1.
